(19) United States
(12) Patent Application Publication
(10) Pub. No.: US 2015/0235118 A1
(43) Pub. Date: Aug. 20, 2015

(54) Two-Dimensional Barcodes Having A Plurality of Different Regions

(71) Applicants: Steven J Simske, Fort Collins, CO (US); Marie Vans, Ft. Collins, CO (US); Brad Loucks, Ft. Collins, CO (US)

(72) Inventors: Steven J Simske, Fort Collins, CO (US); Marie Vans, Ft. Collins, CO (US); Brad Loucks, Ft. Collins, CO (US)

(21) Appl. No.: 14/364,735

(22) PCT Filed: Apr. 26, 2012
(86) PCT No.: PCT/US2012/035213

§ 371 Date: Jun. 12, 2014

(51) Int. Cl. G06K 19/06; G06K 1/12

(52) U.S. Cl. CPC G06K 19/0614; G06K 19/06037; G06K 1/123

(57) ABSTRACT

An embodiment of a two-dimensional barcode has a number of regions. A first region of the number of regions comprises black and white modules and one or more first colored modules. The one or more first colored modules encode data that is readable by reading the one or more first colored modules as white modules and different data that is readable by reading the one or more first colored modules based on their color. A second region of the number of regions comprises black and white modules only or comprises black and white modules and one or more second colored modules. The one or more second colored modules encode data that is readable by reading the one or more second colored modules as white modules and different data that is readable by reading the one or more second colored modules based on their color.

### BACKGROUND

Codes, such as machine-readable codes, e.g., barcodes, are sometimes placed on objects, such as containers, documents, labels, books, software, images, machinery, devices, etc. For example, a barcode may be placed on an object to help protect that object from counterfeiting and other falsifications. A barcode may also be used to identify the object throughout a workflow. For example, a barcode may be placed on an object by each entity within a workflow to identify the object as it moves from one stage to the next in the workflow. For example, a barcode may be used to confirm the identity of the last party to handle the object. Electronic barcodes may be associated with or may be placed on electronic documents. Electronic barcodes can be displayed on an electronic display, such as a computer screen.

Barcodes may be read using a reader, such as a barcode reader (e.g., a barcode scanner). For example, a barcode reader may capture an image of a barcode. Some barcode readers may be configured to decode (e.g., convert) the captured image of the barcode into digital character code, such as binary code.

A barcode may be one or two dimensional. For example, two-dimensional barcodes may be referred to as matrix codes and may include data encoded in black modules and white modules of the two-dimensional barcodes. For example, there is an industry/organizational/public specification that dictates how to read and write using the black and white modules.

### BRIEF DESCRIPTION OF THE DRAWINGS

FIG. 1 illustrates an embodiment of a multi-region two-dimensional barcode.

FIG. 2 illustrates another embodiment of a multi-region two-dimensional barcode.

FIG. 3 is a block diagram of an embodiment of a barcode reader.

FIG. 4 is a block diagram of an embodiment of a barcode generator.

FIGS. 5A-5D illustrate a progressive multi-region two-dimensional barcode at various stages of its evolution, according to another embodiment.

FIG. 6 is a flowchart of a method, according to another embodiment.

FIG. 7 is a flowchart of a method, according to another embodiment.

### DETAILED DESCRIPTION

In the following detailed description, reference is made to the accompanying drawings that form a part hereof, and in which is shown, by way of illustration, specific embodiments. Other embodiments may be utilized and process, structural, logical, and electrical changes may be made without departing from the scope of the present disclosure. The following detailed description is, therefore, not to be taken in a limiting sense.

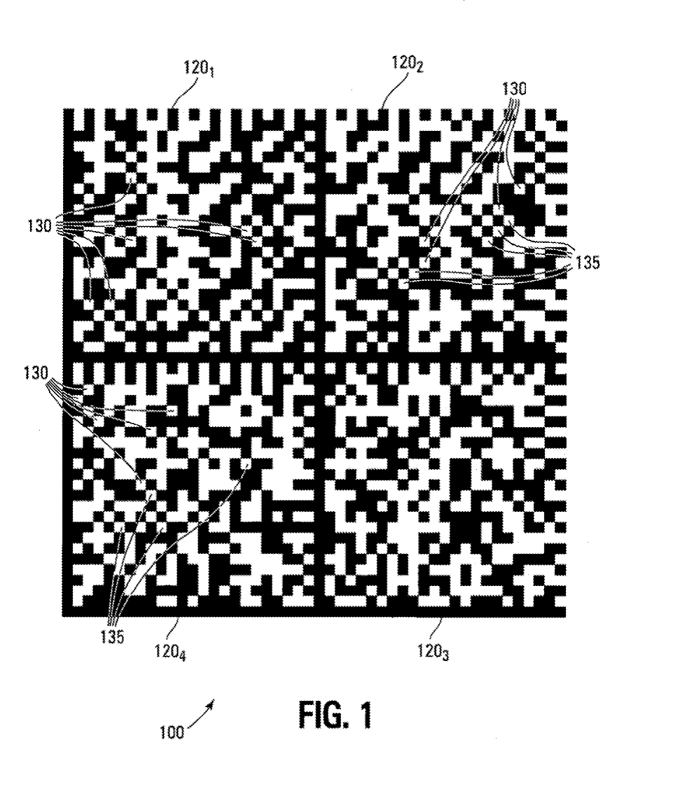

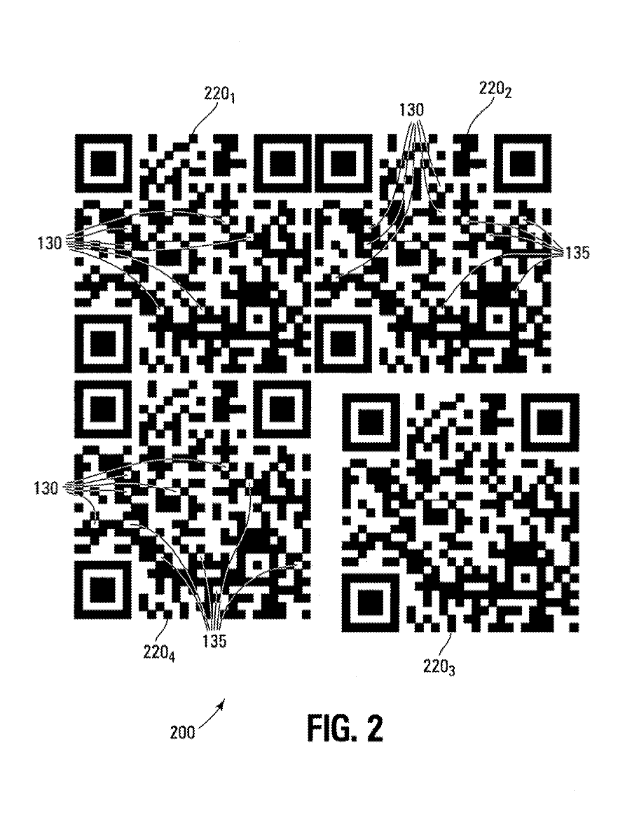

FIG. 1 illustrates an example of a multi-region machine-readable code. such as a multi-region two-dimensional barcode 100, e.g., a multi-region Data-Matrix-type code. FIG. 2 illustrates an example of a multi-region machine-readable code, such as a multi-region two-dimensional barcode 200, e.g., a multi-region-QR (quick-response) type code. Barcodes 100 and 200 may be physical barcodes that may be printed as hardcopy images using a printer or electronic barcodes that may be stored, e.g., in a computer, in the form of digital image data, such as a bitmap. The bitmap may be converted into a particular data format, such as Portable Document Format (PDF), Tag Image File Format (TIFF), Joint Photographic Experts Group (JPEG), a string in a database, or other data format. A physical barcode may be image data that is printed as a hardcopy image on media, such as paper, on a radio-frequency-identification (RFID) tag, etc.

Multi-region barcode 100 may include a plurality of regions 120 (e.g., regions 120₁ to 120₄) that for some embodiments may be individual two-dimensional barcodes, such as individual Data-Matrix-type codes. Multi-region barcode 200 may include a plurality of regions 220 (e.g., regions 220₁ to 220₄) that for some embodiments may be individual two-dimensional barcodes, such as individual QR-type codes.

Multi-region two-dimensional barcodes can store more data than conventional single-region two-dimensional barcodes. For example, some conventional single-region two-dimensional barcodes might store a token for a Uniform Resource Locator (URL) (e.g., due to insufficient storage) that might be resolved on a server and not on a barcode reader that actually scans and decodes the single-region two-dimensional barcode. However, a multi-region two-dimensional barcode, for example, can store an entire URL, e.g., as plaintext, allowing the URL to be resolved on the barcode reader without resorting to a server.

Each of regions 120 of barcode 100 in FIG. 1 and each of regions 220 of barcode 200 in FIG. 2 may include black modules and white modules. For some embodiments, regions 120₁, 120₂, and 120₄ and regions 220₁, 220₂, and 220₄ may include colored modules 130 that may formed by adding colors to modules that were previously white. For example, colored modules 130 may replace the previously white modules. Regions 120₂ and 120₄ and regions 220₂ and 220₄ may also include colored modules 135 that are different colors than colored modules 130, where colored modules 135 may be formed by adding colors to modules that were previously white and/or by adding colors to modules that were previously the colors of modules 130. For example, colored modules 135 may replace the previously white modules and/or the modules that were previously the colors of modules 130. Regions 120₃ and 220₃ may include only black and white modules for some embodiments, as shown in FIGS. 1 and 2, but may include colored modules having one or more of the colors of colored modules 130 and/or one or more of the colors of colored modules 135 for other embodiments.

The colored modules 130 encode data that is readable by reading the one or more first colored modules as white modules, if colored modules 130 are light enough, and different data that is readable by reading the colored modules 130 based on their color. The colored modules 130 may be interpreted by a first two-dimensional barcode reader, such as a standard two-dimensional barcode reader, as white modules only, if colored modules 130 are light enough. The colored modules 135 may be interpreted by the standard two-dimensional barcode reader as black modules only, if colored modules 135 are dark enough.

For example, a standard reader might read a two-dimensional barcode based on contrast in intensity independently of color, e.g., independently of chroma or hue, so that “light” colors might be interpreted effectively as white, e.g., when using the machine-readable instructions, such as image-reading software, for a particular barcode standard of the standard reader. However, the colored modules may be interpreted based on their individual colors using a second two-dimensional barcode reader, such as non-standard two-dimensional barcode reader, e.g., specially configured to decode (e.g., read) multi-region two-dimensional barcodes having colored modules. For example, such non-standard two-dimensional barcode readers may be configured to assign different data states (e.g., binary data states) to different colors.

The regions that include only colored modules 130, such as regions 120₁ and 220₁, in addition to black and white modules may be referred to as “openly-covert” regions, and the two-dimensional barcodes contained in regions 120₁ and 220₁ may be referred to as “openly-covert” two-dimensional barcodes. This is because colored modules 130 may be interpreted as white modules only by a standard (e.g., non-proprietary) reader and according to their specific colors by a non-standard (e.g., proprietary) reader that is specially configured to decode the colors. For example, the black and white modules and colored modules 130 in regions 120₁ and 220₁ may encode data, e.g., that may be referred to as a data channel, that can be decoded (e.g., read) by the standard reader that ignores the chroma of the colored modules 130, interpreting colored modules 130 still as white modules, and thus colored modules 130 are treated as white modules by the standard reader.

Note that “openly-covert” two-dimensional barcodes may include two different sets of encoded data. One set of data (e.g., open data) may be decodable (e.g., readable) by the standard reader and may be encoded by the black and white modules and colored modules 130 that are treated as white modules by the standard reader. The second set of data (e.g., covert data) may be readable by a non-standard reader only and may be encoded by colored modules 130 according to their actual colors. In other words, “openly-covert” two-dimensional barcodes may include two different data channels respectively decodable with standard and non-standard readers. However, non-standard readers may also be configured to treat colored modules 130 as white modules, and thereby may be further configured to read open data encoded by black and white modules and colored modules 130 treated as white modules.

Note that all of the regions 120 of multi-region two-dimensional barcode 100 and all of the regions 220 multi-region two-dimensional barcode 200 may include black and white modules and colored modules 130. Such multi-region two-dimensional barcodes may be referred to as “openly-covert” multi-region two-dimensional barcodes, in that the multi-region two-dimensional barcodes can be read by both a standard reader and the non-standard reader.

The regions that include colored modules 130 and colored modules 135, such as regions 120₂ and 120₄ and regions 220₂ and 220₄, in addition to the black and white modules may be referred to as “proprietary” regions. The two-dimensional barcodes contained in regions 120₂ and 120₄ and regions 220₂ and 220₄ may be referred to as “proprietary” two-dimensional barcodes. This is because the colors of colored modules 135, interpreted as black only by a standard reader, when added to the white modules may cause the two-dimensional barcodes contained in regions 120₂ and 120₄ and regions 220₂ and 220₄ to be totally undecodable (e.g., unreadable) by the standard reader, in that the resulting “black modules,” including the actual black modules and the colored modules 135, may cause the two-dimensional barcodes contained in regions 120₂ and 120₄ and regions 220₂ and 220₄ to be non-standard barcodes.

As such, the colored modules 135 may be said to interfere with the reading of the two-dimensional barcodes contained in regions 120₂ and 120₄ and regions 220₂ and 220₄ by a standard reader. That is, the data encoded by the black and white modules, can be made unreadable by a standard reader when colors added to the white modules cause the white modules to become too dark. Note that the two-dimensional barcodes contained in regions 120₂ and 120₄ and regions 220₂ and 220₄ may only be decoded by a non-standard reader specially configured to decode two-dimensional barcodes having colored modules 135 that are dark enough to be taken as black by the standard reader.

Some proprietary two-dimensional barcodes may include data encoded in colored modules 130, data encoded in colored modules 135, data encoded in the actual white modules, and data encoded in the actual black modules, where the data encoded in colored modules 130, the data encoded in colored modules 135, the data encoded in the actual white modules, and the data encoded in the black modules are decodable by the non-standard reader. Note further that all of the regions 120 of multi-region two-dimensional barcode 100 and all of the regions 220 multi-region two-dimensional barcode 200 may include black and white modules and colored modules 135, with or without colored modules 130. Such multi-region two-dimensional barcodes may be referred to as proprietary multi-region two-dimensional barcodes, in that the multi-region two-dimensional barcodes can only be read by a non-standard reader.

A barcode reader may be defined as any device that is configured to capture an image of a barcode and that is configured to decode the captured image. For example, a barcode reader may include the machine-readable instructions, such as software, that decode an image of a barcode into digital character code, such as binary code. For example, the machine-readable instructions may be on a computer, and an image-capturing device may be coupled to the computer. A mobile telephone with a camera that is configured to decode barcodes may be considered to be a barcode reader.

A standard two-dimensional barcode reader might operate according to the ISO/IEC 15426-2 accuracy standard and/or the ISO/IEC 15415 and ISO/IEC 15416 quality specifications. Standard two-dimensional barcode readers are typically configured to decode standard multi-region two-dimensional barcodes, e.g., multi-region two-dimensional barcodes configured with black and white modules only. For example, each of the regions of a standard multi-region two-dimensional barcode would be configured as a standard two-dimensional barcode having black and white modules only

Regions 120₃ (FIG. 1) and 220₃ (FIG. 2) are examples of standard two-dimensional barcodes having black and white modules only. For example, region 120₃ may contain a standard Data Matrix code, and region 220₃ may contain a standard QR code.

As such, region 120₃ is decodable by a standard two-dimensional barcode reader, such as a standard Data Matrix code reader, and region 220₃ is decodable by a standard two-dimensional barcode reader, such as a standard QR code reader. For example, ISO/IEC 16022: “Information technology—Automatic identification and data capture techniques—Data Matrix bar code symbology specification” may govern the reading of a standard Data Matrix code with standard Data Matrix code reader, and ISO/IEC 18004:2006: “Information technology—Automatic identification and data capture techniques—QR Code 2005 bar code symbology specification” may govern the reading of a standard QR code with standard QR code reader.

For some embodiments, region 120₃ may be read independently of regions 120₁, 120₂, and 120₄ using a standard reader, and region 220₃ may be read independently of regions 220₁, 220₂, and 220₄ using a standard reader. A region of a multi-region two-dimensional barcode that includes only a standard two-dimensional barcode, such as region 220₃, may be offset from and out of contact with the other regions of the multi-region two-dimensional barcode to facilitate its independent reading by a standard two-dimensional barcode reader. Note, however, that the regions 120 of barcode 100 and regions 220 of barcode 200 may physically contact each other for other embodiments.

The colored modules 130 may include colors that are sufficiently unsaturated, e.g., light, so that a standard barcode reader interprets them as being white. For example, colored modules 130 may be sufficiently unsaturated to be treated as white by the standard reader when they include colors that are at most 25 percent of the “darkness” of the black modules, e.g., the black modules may be at least 75 percent more saturated than colored modules 130. For some embodiments, colored modules 130 may include the colors of yellow (Y), magenta (M), and cyan (C). For example, colored modules 130 may be formed by adding the colors of yellow (Y), magenta (M), and cyan (C) to modules that were previously white. In other words, yellow (Y), magenta (M), and/or cyan (C) modules may replace modules that were previously white.

Colored modules 135 may include colors that are sufficiently saturated, e.g., dark, so that a standard barcode reader interprets them as being black. For example, colored modules 135 may be sufficiently saturated to be treated as black when they include colors that are 30 to 70 percent of the “darkness” of the black modules, e.g., the black modules may be 30 to 70 percent more saturated than colored modules 135. For some embodiments, colored modules 135 may include the colors of red (R), blue (B), and green (G). For example, colored modules 135 may be formed by adding the colors of red (R), blue (B), and green (G) to modules that were previously white. In other words, red (R), blue (B), and/or green (G) modules may replace modules that were previously white. For some embodiments, red (R), blue (B), and/or green (G) modules may replace modules that were previously yellow (Y), magenta (M), and/or cyan (C).

Multi-region two-dimensional barcodes 100 and 200 may store error correction (ECC) data that allow errors in the data stored in two-dimensional barcodes 100 and 200 to be detected and, in some cases, recovered. For some embodiments, the ECC data may extend across more than one of the regions (e.g., all the regions) of barcodes 100 and 200. For example, if data, including the ECC data, originally stored in one of the regions is destroyed, the ECC data in the remaining regions may be used to reconstruct the destroyed data. Alternatively, each region may store its own ECC data. For some embodiments, color may be added to some of the white modules until these white modules become black and the ECC will allow the barcode to be read, e.g., by the non-standard reader.

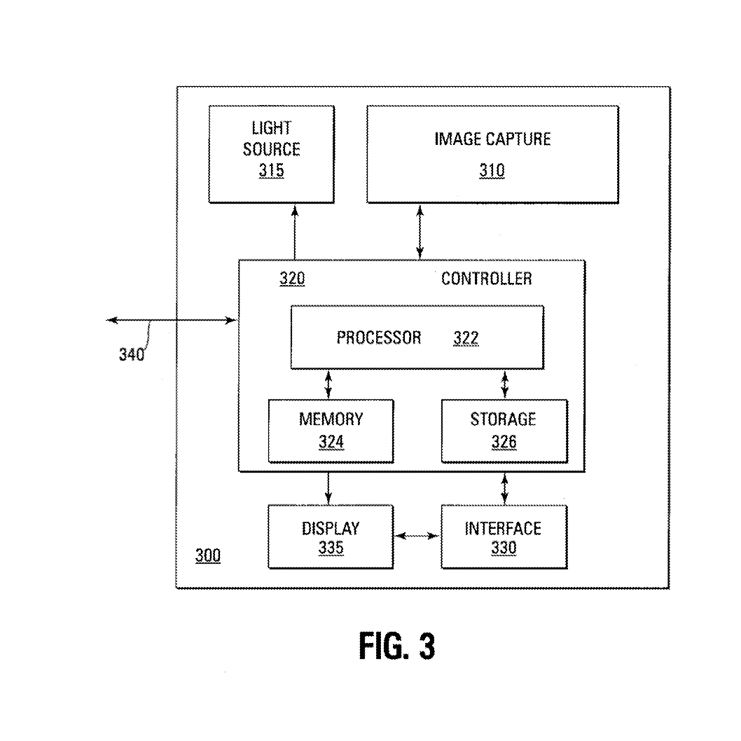

FIG. 3 is a block diagram illustrating an embodiment of a barcode reader 300 configured to read (e.g., capture and decode) multi-region two-dimensional barcodes, such as barcodes 100 and 200. Barcode reader 300 may be a mobile (e.g., handheld) device that may be moved relative to a stationary barcode or a stationary or fixed-position device that remains stationary or fixed while a barcode is moved past it.

Barcode reader 300 may include an image-capturing device 310, such as a camera, configured to capture an image of a barcode. For some embodiments, image-capturing device 310 may be configured to capture an image of a multi-region two-dimensional barcode and to convert the image into digital image data (e.g., a bitmap, PDF, TIFF, JPEG, etc.), representing the multi-region two-dimensional barcode. In other words, image-capturing device 310 may be configured to capture an image of a multi-region two-dimensional barcode and to convert that image into an electronic version of the multi-region two-dimensional barcode. Barcode reader 300 may include a light source 315 configured to illuminate a barcode prior to reading the barcode.

Barcode reader 300 may include a controller 320 (e.g., a decoder) that may be configured to allow barcode reader 300 to perform the methods and functions disclosed herein for reading the multi-region two-dimensional barcodes disclosed herein, such as barcodes 100 and 200. For some embodiments, the functionality of image-capturing device 310 that converts the captured image of a multi-region two-dimensional barcode into digital image data representing the multi-region two-dimensional barcode may be incorporated in controller 320.

Controller 320 may include a processor 322 for processing machine-readable instructions, such as processor-readable (e.g., computer-readable) instructions. The machine-readable instructions may configure processor 322 to allow controller 320 to allow barcode reader 300 to perform the methods and functions associated with capturing and decoding the multi-region two-dimensional barcodes disclosed herein. In other words, the machine-readable instructions may configure controller 320 to allow barcode reader 300 to perform the methods and functions associated with capturing and decoding the multi-region two-dimensional barcodes disclosed herein.

For example, the machine-readable instructions may be specially configured to decode the multi-region two-dimensional barcodes disclosed herein, such as barcodes 100 and 200, e.g., multi-region two-dimensional barcodes having one or more regions with colored modules 130 and/or colored modules 135 (FIGS. 1 and 2).

The machine-readable instructions may be stored in a memory 324 coupled to processor 322, such as a non-transitory computer-usable medium, and may be in the form of software, firmware, hardware, or a combination thereof. In a hardware solution, the machine-readable instructions may be hard coded as part of processor 322, e.g., an application-specific integrated circuit (ASIC) chip. In a software or firmware solution, the instructions may be stored for retrieval by the processor 322. Some additional examples of non-transitory computer-usable media may include static or dynamic random access memory (SRAM or DRAM), read-only memory (ROM), electrically erasable programmable ROM (EEPROM) memory, such as flash memory, magnetic media and optical media, whether permanent or removable, etc. Some consumer-oriented computer applications are software solutions provided to the user in the form of downloads, e.g., from the Internet, or removable computer-usable non-transitory media, such as a compact disc read-only memory (CD-ROM) or digital video disc (DVD).

Controller 320 may include storage device 326, such as a hard drive, removable flash memory, etc. Storage device 326 may be configured to store decryption keys, such as PKI (Public Key Infrastructure) and IBE (Identity Based Encryption) decryption keys, configured to respectively decrypt data decoded from the multi-region two-dimensional barcodes.

A human-machine interface 330 may be coupled to controller 320. Interface 330 may be configured to interface with a number of input devices, such as a keyboard and/or pointing device, including, for example, a mouse. Interface 330 may be configured to interface with a display 335 that may include a touchscreen that may function as an input device. Controller 320 may be coupled to a data network, such as the Internet, a Local Area Network (LAN), etc., and/or a computer via an interface 340.

It should be recognized that the functionality of the various block components described with reference to FIG. 3 may not necessarily be segregated to distinct components or component portions of a barcode reader. For example, a single component or component portion of a barcode reader could be adapted to perform the functionality of more than one block component of FIG. 3. Alternatively, one or more components or component portions of a barcode reader could be combined to perform the functionality of a single block component of FIG. 3.

For some embodiments, processor 322, memory 324, storage device 326, and/or human-machine interface 330 may be implemented in a computer and image-capturing device 310 might be removably coupleable to the computer.

For some embodiments, one of the regions of a multi-region two-dimensional barcode, such as barcode 100 or barcode 200, might be associated with another region of that multi-region two-dimensional barcode. For example, one of the regions might store data, e.g., encoded in colored modules 130 or colored modules 135, that may be used to activate data, e.g., encoded in colored modules 130 or colored modules 135, in another region. For example, controller 320 may be configured to decode data (e.g., a one-time usable, randomly-generated, binary sequence, also called a nonce) from a first region and to decode data from a second region and to combine the decoded data from the first and second regions (e.g., by performing an XOR operation) to produce third data (e.g., intelligible data).

Data in a region of barcode 100 or barcode 200 might be unencrypted data, such as plaintext, while data in another region might be encrypted. For example, the plaintext and the encrypted data may be encoded in colored modules 130 and/or colored modules 135. Alternatively, the plaintext may be encoded in the barcode's set of black and white modules or in a region that contains a standard two-dimensional barcode, such as region 120₃ or region 220₃. Controller 320 may be configured to decrypt encrypted data according to a public standard, such as PKI, e.g., to decrypt the encrypted data using a PKI key.

Data in a region of barcode 100 or barcode 200 might be unencrypted data, such as plaintext, while data in another region might include data with a digital signature, e.g., data that can be verified with a public key signing. For example, the data that can be verified with a public key signing may be encoded in colored modules 130 and/or colored modules 135.

Data in a region of barcode 100 or barcode 200 might be a digital signature for data in another region, e.g., where the digital signature may be encoded in colored modules 130 and/or colored modules 135 and the data in the other region may be encoded in colored modules 130 and/or colored modules 135. Alternatively, the other region might contain black and white modules only, and the data might be encoded in those black and white modules.

Data in a region of barcode 100 or barcode 200 might be encrypted data readable according to PKI, while data in another region might be encrypted data readable according to an IBE protocol. The data readable according to PKI and IBE may be encoded in colored modules 130 and/or colored modules 135.

A region of barcode 100 or barcode 200 might store an entire URL, while another region might store a token for another URL that may be used to look up the other URL on a server, e.g., on the Internet. For example, controller 320 may be configured to decode the token and use the token to look up the URL on the server.

A URL and table entry from the URL site might be in different regions of barcode 100 or barcode 200. For example, controller 320 may be configured to decode the URL and the table entry from the different regions and to use the URL to connect reader 300 to a website. The table entry might dictate the settings on the website once reader 300 is connected.

A URL might be stored in a first region of a multi-region two-dimensional barcode, such as barcode 100 or barcode 200, a nonce in a second region, a nonce interpretation algorithm in a third region, and a first password in a fourth region. For example, controller 320 may decode the URL from the first region, the nonce from the second region, the nonce interpretation algorithm from the third region, and the first password from the fourth region. Controller 320 may then use the nonce interpretation algorithm to descramble the nonce. Controller 320 may then combine the descrambled nonce with the first password, e.g., by performing an XOR operation, to produce a second password. Controller 320 may then use the second password to activate the URL or a service at the URL site, for example. The URL, nonce, the first password, and/or the nonce interpretation algorithm may be encoded in colored modules 130 and/or colored modules 135.

One or more of the regions of a multi-region two-dimensional barcode, such as barcode 100 or barcode 200, may contain a difference pattern, such as a difference score, e.g., a Hamming distance. For example, the difference pattern may include the differences between a biometric marker, such as a fingerprint, and a reference biometric marker. The difference pattern may be contained in the region of the barcode and not the actual biometric marker, e.g., allowing secure handling of the biometric marker. The difference pattern may be encoded in colored modules 130 and/or colored modules 135.

Multi-region two-dimensional barcodes 100 and 200 may start out as standard multi-region two-dimensional barcodes, e.g., having only black and white modules. For example, each of regions 120 and 220 may contain a standard two-dimensional barcode.

Subsequently, some of the white modules may be replaced by colored modules 130 by adding the colors of colored modules 130 to those white modules to form colored modules 130, such as during certain stages of a workflow. Therefore, the colors of modules 130 in two-dimensional barcodes 100 and 200 may be added sometime after the black and white modules were formed. For example, the colors of colored modules 130 may be written over white modules in standard two-dimensional barcodes in regions 120₁, 120₂, and 120₄ of multi-region two-dimensional barcode 100 and over white modules in standard two-dimensional barcodes in regions 220₁, 220₂, and 220₄ of multi-region two-dimensional barcode 200.

Subsequently, such as during a later stage of the workflow, colored modules 135 may replace some white modules by adding the colors of colored modules 135 to those white modules, and/or colored modules 135 may replace some colored modules 130 by adding the colors of colored modules 135 to those colored modules 130. Therefore, the colors of colored modules 135 in two-dimensional barcodes 100 and 200 may be added sometime after the colored modules 130 were formed, for example.

Multi-region two-dimensional barcodes that include colored modules that are added to standard multi-region two-dimensional barcodes or colored modules that are added at different stages in the evolution of the multi-region two-dimensional barcodes may be referred to as progressive multi-region two-dimensional barcodes. For some embodiments, colored modules 130 and/or colored modules 135 may be added to different regions 120 or different regions 220 at different stages in the evolution of a multi-region two-dimensional barcode, e.g., at different stages of a workflow.

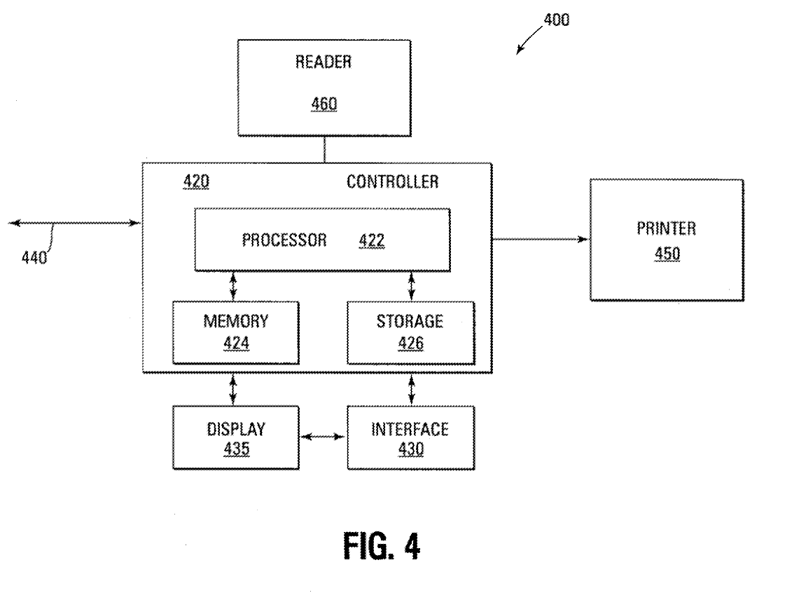

FIG. 4 is a block diagram illustrating an embodiment of a barcode generator 400. Barcode generator 400 may include a controller 420 that may be configured to allow generator 400 to perform the methods and functions disclosed herein for generating (e.g., automatically) the multi-region two-dimensional barcodes disclosed herein, such as barcodes 100 and 200. For some embodiments, barcode generator 400 may be configured to print over an existing barcode, e.g. affixed to an object.

Controller 420 may include a processor 422 for processing machine-readable instructions, such as processor-readable (e.g., computer-readable) instructions. The machine-readable instructions may configure processor 422 to allow controller 420 to allow barcode generator 400 to perform the methods and functions associated with generating (e.g., automatically) the multi-region two-dimensional barcodes disclosed herein. In other words, the machine-readable instructions configure controller 420 to allow barcode generator 400 to perform the methods and functions associated with generating the multi-region two-dimensional barcodes disclosed herein.

The machine-readable instructions may be stored in a memory 424 coupled to processor 422, such as a non-transitory computer-usable medium, and may be in the form of software, firmware, hardware, or a combination thereof. In a hardware solution, the processor-readable instructions may be hard coded as part of processor 422, e.g., an application-specific integrated circuit (ASIC) chip. In a software or firmware solution, the instructions may be stored for retrieval by the processor 422.

Controller 420 may include storage device 426, such as a hard drive, removable flash memory, etc. Storage device 426 may be configured to store digital image data (e.g., bitmaps, PDFs, TIFFs, JPEGs, etc.) corresponding to (e.g., representing) the multi-region two-dimensional barcodes disclosed herein, such as barcodes 100 and 200. Storage device 426 may be configured to store encryption keys such as PKI and IBE encryption keys configured to respectively encrypt data to be encoded into the multi-region two-dimensional barcodes, e.g., as colored modules 130 and/or colored modules 135.

A human-machine interface 430 may be coupled to controller 420. Interface 430 may be configured to interface with a number of input devices, such as a keyboard and/or pointing device, including, for example, a mouse. Interface 430 may be configured to interface with a display 435 that may include a touchscreen that may function as an input device. Controller 420 may be coupled to a data network, such as the Internet, a Local Area Network (LAN), etc., and/or a computer via an interface 440.

Barcode generator 400 may include a printer 450 coupled to controller 422. For some embodiments, barcode generator 400 may include a reader 460 coupled to controller 420. Reader 460 may be similar to (e.g., the same as) the barcode reader 300 discussed above in conjunction with FIG. 3. For example, reader 460 may be configured to read multi-region two-dimensional barcodes, such as barcodes 100 and 200, having one or more regions with colored modules, such as colored modules 130 and/or colored modules 135. Note that the functionality of controller 322 of barcode reader 300 may be incorporated into controller 420 and the functionality of interface 330 and display 335 of barcode reader 300 might be incorporated into interface 430 and display 435.

For some embodiments, processor 422, memory 424, and storage 426 may be part of a computer, such as a personal computer. As such, the machine-readable instructions may allow processor 422 to create or modify electronic versions of multi-region two-dimensional barcodes and to attach them to electronic documents.

It should be recognized that the functionality of the various block components described with reference to FIG. 4 may not necessarily be segregated to distinct components or component portions of a barcode generator. For example, a single component or component portion of a barcode generator could be adapted to perform the functionality of more than one block component of FIG. 4. Alternatively, one or more components or component portions of a barcode generator could be combined to perform the functionality of a single block component of FIG. 4.

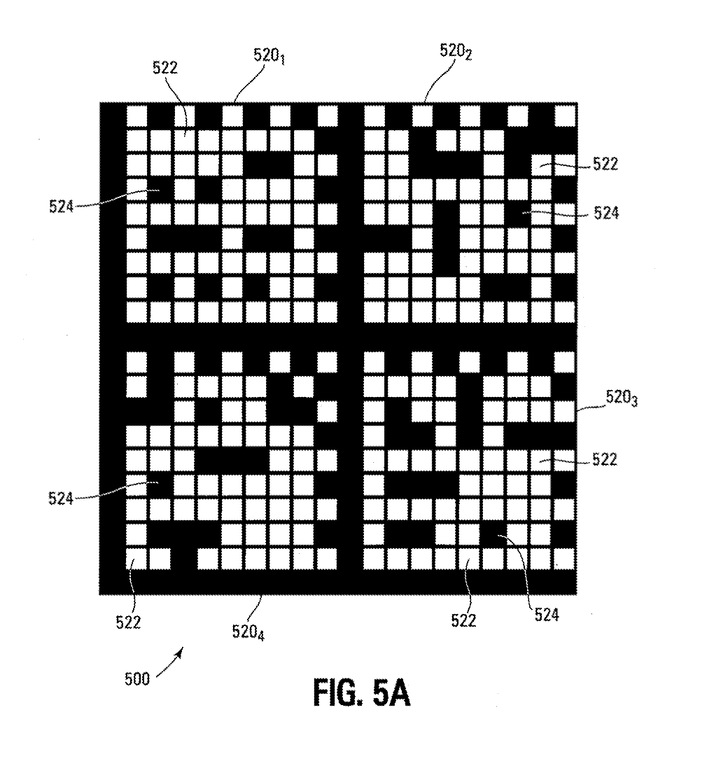

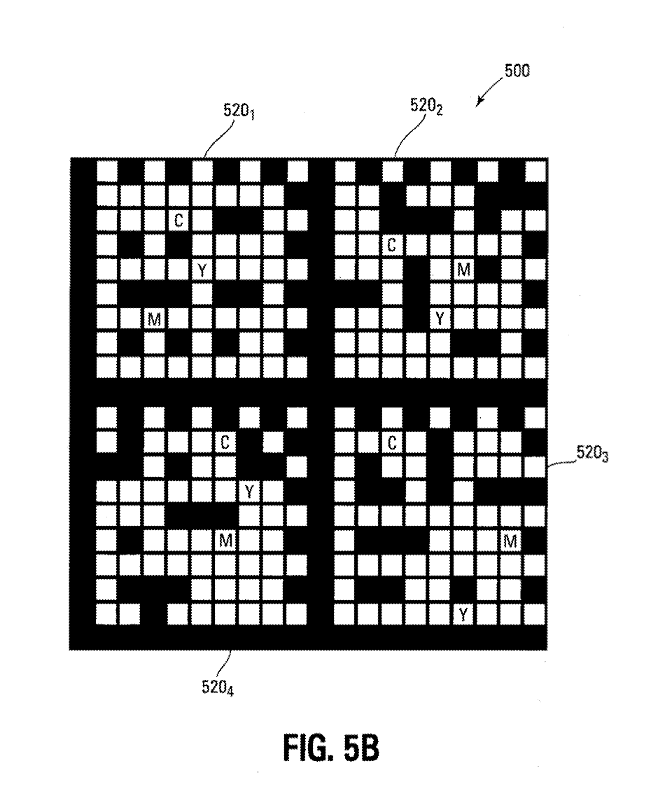

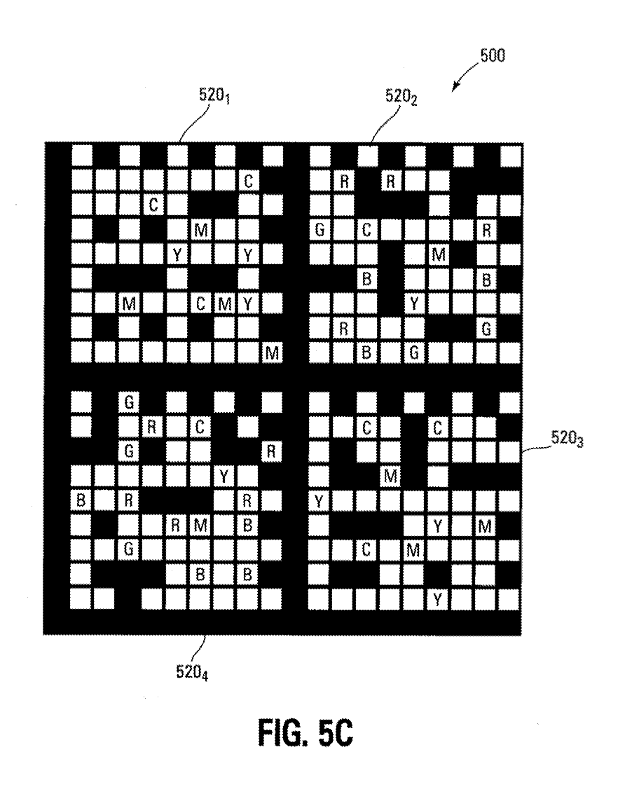

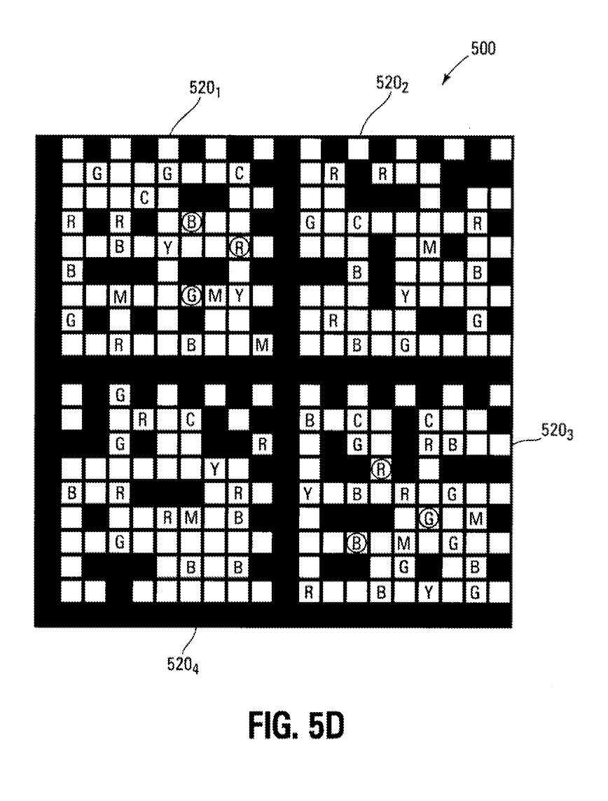

FIGS. 5A-5D illustrate a progressive multi-region two-dimensional barcode 500 at various stages of its evolution. For example, barcode generator 400 may be configured to form barcode 500.

FIG. 5A may correspond to a stage in the evolution of barcode 500, where barcode 500 is a standard multi-region two-dimensional barcode that is readable with a standard reader. At the stage, depicted in FIG. 5, multi-region two-dimensional barcode 500 may include regions 520₁, 520₂, 520₃, and 520₄, each being a standard two-dimensional barcode. Each region 520 may include a plurality of white modules 522 and a plurality of black modules 524. In other words, each region 520 may include a two-dimensional array of black and white modules. The black modules 524 and white modules 522 in each region 520 may encode data that is readable with a standard reader.

Barcode generator 400 may receive data from a user via interface 430, and controller 420 may encode that data into black and white digital image data corresponding to the black modules 524 and the white modules 522 in each region 520. For example, the black image data may replace white image data in each region 520 to form an electronic version of the barcode 500 in FIG. 5A. Printer 450 may then print a hardcopy image of the electronic version of the barcode on media, such as paper.

FIG. 5B illustrates barcode 500 after it has progressed to another stage, e.g., from the stage of FIG. 5A. The barcode 500 at the stage in FIG. 5B may be formed by adding data encoded as yellow (Y), cyan (C), and magenta (M) to the white modules in each region 520 of the barcode in FIG. 5A. For example, each region 520 now includes yellow (Y), cyan (C), and magenta (M) colored modules. The yellow (Y), cyan (C), and magenta (M) colored modules thus correspond to a different (e.g., later) stage in the evolution of barcode 500 than the black and white modules. That is, the data encoded by the yellow (Y), cyan (C), and magenta (M) colored modules may be added to barcode 500 at a later time than the data encoded in the black and white modules.

The barcode in FIG. 5B may be a new barcode, e.g., created by barcode generator 400. For example, printer 450 might print a new hardcopy barcode on a media sheet, such as paper. Alternatively, the barcode in FIG. 5B may be formed from an existing barcode, e.g., the barcode in FIG. 5A, by writing over the existing barcode, e.g., with barcode generator 400. For example, barcode generator 400 may be positioned over the barcode of FIG. 5A so that printer 450 can print the yellow (Y), cyan (C), and magenta (M) onto the white modules of the barcode of FIG. 5A.

For some embodiments, barcode generator 400 might read the barcode of FIG. 5A. The user may then input new data to be added to the barcode of FIG. 5A via interface 430. Controller 420 may then encode the new data into the yellow (Y), cyan (C), and magenta (M) and add the new data encoded by the yellow (Y), cyan (C), and magenta (M) to the barcode read from FIG. 5A. For some embodiments, controller 420 might encrypt the new data before encoding it into yellow (Y), cyan (C), and magenta (M).

The yellow (Y), cyan (C), and magenta (M) may be unsaturated to a level where a standard reader interprets them as white only. As such, the standard reader may only read the data encoded in black and white modules and data encoded in the yellow (Y), cyan (C), and magenta (M) by reading the yellow (Y), cyan (C), and magenta (M) as white modules. Note that the presence of the yellow (Y), cyan (C), and magenta (M) modules does not change the data that is readable by the standard reader. For example, the data that is encoded by the yellow (Y), cyan (C), and magenta (M) modules that is read by reading the yellow (Y), cyan (C), and magenta (M) modules as white modules with the standard reader can be the same as data that is encoded by the white modules that are replaced by the yellow (Y), cyan (C), and magenta (M) modules and that is read by the standard reader.

However, reader 300 in FIG. 3 may be configured to read the data encoded in yellow (Y), cyan (C), and magenta (M) modules, according to their actual colors. For example, reader 300 may read different data encoded in the yellow (Y), cyan (C), and magenta (M) by reading the yellow (Y), cyan (C), and magenta (M) based on their actual colors. Note that the barcode in FIG. 5B is an example of an “openly covert” multi-region two-dimensional barcode.

For some embodiments, controller 420 may convert the new data into colored (e.g., yellow (Y), cyan (C), and magenta (M)) image data and may replace white image data corresponding to a portion of the white modules in each of the regions of the barcode 500 of FIG. 5A with the colored image data to create a new electronic version of the multi-region barcode.

FIG. 5C illustrates barcode 500 after it has progressed to another stage, e.g., from the stage of FIG. 58B. The barcode 500 at the stage in FIG. 5C may be formed by adding data encoded as yellow (Y), cyan (C), and magenta (M) to the white modules in regions 520₁ and 520₃ in the barcode in FIG. 5B and adding data encoded as red (R), blue (B), and green (G) to the white modules in regions 520₂ and 520₄ in the barcode in FIG. 5B. For example, regions 520₂ and 520₄ now include yellow (Y), cyan (C), and magenta (M) colored modules and red (R), blue (B), and green (G) colored modules.

For some embodiments, barcode generator 400 might read the barcode of FIG. 5B. The user may then input new data to be added to the regions 520₁ and 520₃ of the barcode of FIG. 5B and the new data to be added to regions 520₂ and 520₄. Controller 420 may then encode the new data to be added to the regions 520₁ and 520₃ into the yellow (Y), cyan (C), and magenta (M). Controller 420 may encode the new data to be added to the regions 520₂ and 520₄ into the red (R), blue (B), and green (G) and add the new data to the regions 520₂ and 520₄.

For some embodiments, controller 420 may convert the new data to be added to the regions 520₁ and 520₃ into new yellow (Y), cyan (C), and magenta (M) image data. Controller 420 may replace white image data corresponding to a portion of the white modules in regions 520₁ and 520₃ in FIG. 5B with the new yellow (Y), cyan (C), and magenta (M) image data to create new electronic versions of regions 520₁ and 520₃ in FIG. 5C.

Controller 420 may convert the new data to be added to the regions 520₂ and 520₄ into red (R), blue (B), and green (G) image data. Controller 420 may replace white image data corresponding to a portion of the white modules in regions 520₂ and 520₄ in FIG. 5B with the red (R), blue (B), and green (G) image data to create new electronic versions of regions 520₂ and 520₄ in FIG. 5C.

Regions 520₁ and 520₃ of the barcode of FIG. 5C are examples of “openly-covert” regions. As such, a standard reader may only read data in regions 520₁ and 520₃ encoded in the black modules and the white modules and read data in the regions 520₁ and 520₃ encoded in the yellow (Y), cyan (C), and magenta (M) modules by reading the yellow (Y), cyan (C), and magenta (M) modules as white modules. However, reader 300 may read the data encoded in the black and white modules and may read other data encoded in the yellow (Y), cyan (C), and magenta (M) modules by reading the yellow (Y), cyan (C), and magenta (M) modules according to their actual colors.

The red (R), blue (B), and green (G) colored modules in regions 520₂ and 520₄ may be interpreted the standard reader as “black” modules only, if the red (R), blue (B), and green (G) colored modules are dark enough, and may interfere with the reading of the actual black and white modules in regions 520₂ and 520₄ by the standard reader, meaning the standard reader might not be able to read regions 520₂ and 520₄ in the barcode in FIG. 5C. As such, regions 520₂ and 520₄ in the barcode in FIG. 5C are examples of “proprietary” regions. However, reader 300 may be configured to read the data in regions 520₂ and 520₄ encoded by the yellow (Y), cyan (C), and magenta (M) colored modules and the data in regions 520₂ and 520₄ encoded by the red (R), blue (B), and green (G) colored modules as well as the data in regions 520₂ and 520₄ encoded by the black and white modules. Note that if the red (R), blue (B), and green (G) colored modules are dark enough, they can replace black, and if the yellow (Y), cyan (C), and magenta (M) colored modules are light enough, they can replace white.

The barcode in FIG. 5C may be a new barcode, e.g., created by barcode generator 400 and printed out as a hardcopy by printer 450. Alternatively, the barcode in FIG. 5C may be formed from an existing barcode, e.g., the barcode in FIG. 5B, by writing over the existing barcode, e.g., with barcode generator 400. For example, barcode generator 400 may be positioned over the barcode of FIG. 5B so that printer 450 can print yellow (Y), cyan (C), and magenta (M) on white modules of regions 520₁ and 520₂ of the barcode of FIG. 5B and print red (R), blue (B), and green (G) on white modules of regions 520₂ and 520₄ of the barcode of FIG. 5B.

FIG. 5D illustrates barcode 500 after it has progressed to another stage, e.g., from the stage of FIG. 5C. The barcode 500 at the stage in FIG. 50D may be formed by adding data encoded as red (R), blue (B), and green (G) to regions 520₁ and 520₃ in the barcode in FIG. 5C, while leaving regions 520₂ and 520₄ in the barcode in FIG. 5D the same as in FIG. 5C. This illustrates that different regions of a progressive multi-region barcode may progress independently of each other.

The red (R), blue (B), and green (G) modules that are circled are modules where yellow (Y), cyan (C), and magenta (M) modules in FIG. 5C have been replaced by red (R), blue (B), and green (G) modules. For example, in region 520₁, the new red (R), blue (B), and green (G) circled modules were respectively yellow (Y), magenta (M), and cyan (C) modules in FIG. 5C, and in region 520₃, the new red (R), blue (B) and green (G) circled modules were respectively magenta (M), cyan (C), and yellow (Y) modules in FIG. 5C. The remaining new red (R), blue (B), and green (G) modules were previously white modules.

For some embodiments, barcode generator 400 might read the barcode of FIG. 5C. The user may then input new data to be added to the regions 520₁ and 520₃ in the barcode in FIG. 5C. Controller 420 may then encode the new data to be added to the regions 520₁ and 520₃ into the red (R), blue (B), and green (G) and add the new data to the regions 520₁ and 520₃.

For some embodiments, controller 420 may convert the new data to be added to the regions 520₁ and 520₃ into new red (R), blue (B), and green (G) image data. Controller may replace white image data corresponding to a portion of the white modules in regions 520₁ and 520₃ in FIG. 5C with red (R), blue (B), and green (G) image data and may replace yellow (Y), magenta (M), and cyan (C) image data corresponding to yellow (Y), magenta (M), and cyan (C) modules in FIG. 5C with red (R), blue (B), and green (G) image data corresponding to the circled red (R), blue (B), and green (G) modules in regions 520₁ and 520₃. This creates new electronic versions of regions 520₁ and 520₃ and thus a new electronic version of the multi-region barcode in FIG. 5C.

The barcode in FIG. 5D may be a new barcode, e.g., created by barcode generator 400 and printed out as a hardcopy by printer 450. Alternatively, the barcode in FIG. 5D may be formed from an existing barcode, e.g., the barcode in FIG. 5C, by writing over the existing barcode, e.g., with barcode generator 400. For example, barcode generator 400 may be positioned over the barcode of FIG. 5C so that printer 450 can print red (R), blue (B), and green (G) on the regions 520₁ and 520₃ in the barcode of FIG. 5C.

For embodiments, where the barcode of FIG. 5C is written over, the yellow (Y), magenta (M), and cyan (C) modules in FIG. 5C that are respectively the red (R), blue (B), and green (G) circled modules in region 520₁ of FIG. 5D may be respectively written over with magenta (M), cyan (C), and yellow (Y) to respectively produce the red (R), blue (B), and green (G) circled modules in region 520₁ of FIG. 5D. Similarly, the magenta (M), cyan (C), and yellow (Y) modules in FIG. 5C that are respectively the red (R), blue (B), and green (G) circled modules in region 520₃ of FIG. 5D may be respectively written over with yellow (Y), magenta (M), and cyan (C) to respectively produce the red (R), blue (B), and green (G) circled modules in region 520₃ of FIG. 5D.

The red (R), blue (B), and green (G) colored modules in regions 520₁ and 520₃ may be interpreted by a standard reader as “black” modules only, if they are dark enough, and may interfere with the reading of the actual black and white modules in regions 520₁ and 520₃ with the standard reader, meaning the standard reader cannot read regions 520₁ and 520₃ in the barcode in FIG. 5D. As such, regions 520₁, 520₂, 520₃, and 520₄ in the barcode in FIG. 5D are examples of “proprietary” regions. Therefore, the barcode 500 in FIG. 5D is an example of a proprietary progressive multi-region two-dimensional barcode that cannot be read with a standard reader. However reader 300 may be configured to read the barcode 500 in FIG. 5D.

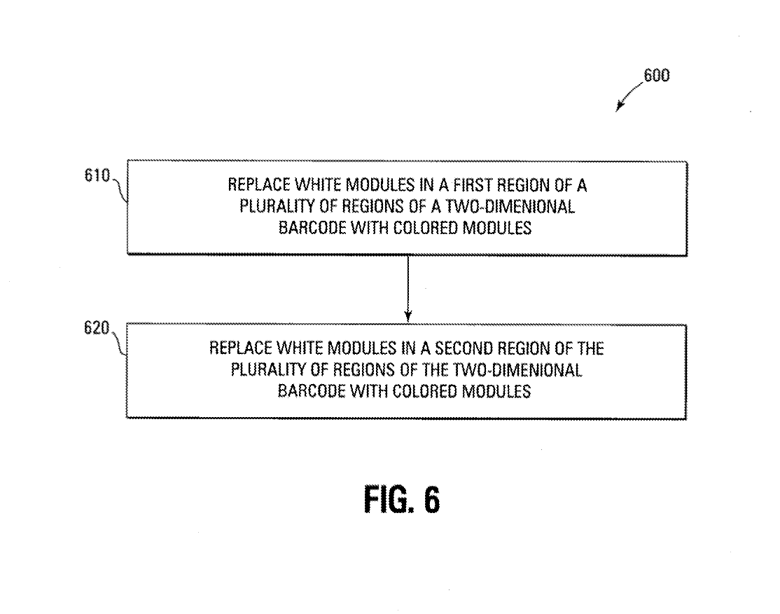

For one embodiment, the machine-readable instructions may configure processor 422 to allow controller 420 to allow a barcode generator, such as barcode generator 400, to perform a method 600 of generating a barcode, as illustrated by the flowchart in FIG. 6. For example, method 600 may be used to automatically generate the barcode in FIG. 5B from the barcode in FIG. 5A, the barcode of FIG. 5C from the barcode of FIG. 5B, etc. An automatically generated barcode may be a barcode that is generated by a device, such as the barcode generator, e.g., in response to inputs from a user.

At block 610, white modules in a first region of a plurality of regions of a two-dimensional barcode are replaced with colored modules. At block 620, white modules in a second region of the plurality of regions of the two-dimensional barcode are replaced with colored modules. The colored modules in the first and second regions may be configured to be interpreted by a first reader as white modules only or as black modules only. The colored modules in the first and second regions may be configured to be interpreted by a second reader based on their colors.

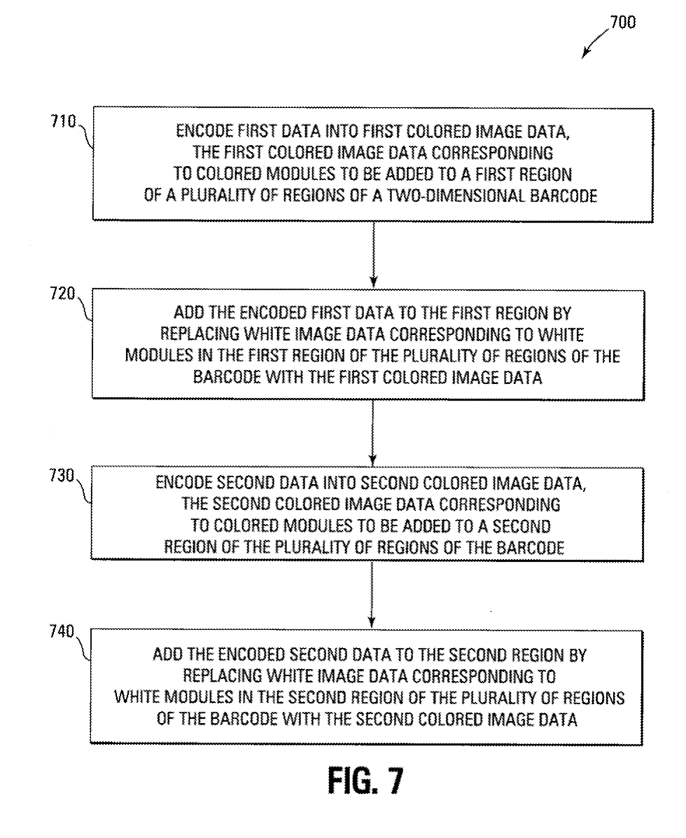

For one embodiment, the machine-readable instructions may configure processor 422 to allow controller 420 to allow a barcode generator, such as barcode generator 400, to perform a method 700 of generating a barcode, as Illustrated by the flowchart in FIG. 7. For example, method 700 may be used to automatically generate the barcode in FIG. 5B from the barcode in FIG. 5A, the barcode of FIG. 5C from the barcode of FIG. 5B, etc.

At block 710, first data may be encoded into first colored image data, e.g., using controller 420. The first colored image data may correspond to colored modules to be added to a first region of a plurality of regions of a two-dimensional barcode. The encoded first data may be added to the first region by replacing white image data corresponding to white modules in the first region of the plurality of regions of the barcode with the first colored image data at block 720. Second data may be encoded into second colored image data, e.g., using controller 420, at block 730. The second colored image data may correspond to colored modules to be added to a second region of the plurality of regions of the barcode. The encoded second data may be added to the second region by replacing white image data corresponding to white modules in the second region of the plurality of regions of the barcode with the second colored image data at block 740.

The encoded first data is readable by reading the colored modules in the first region based on their color, and the encoded second data is readable by reading the colored modules in the second region based on their color. The colored modules in the first region also encode data that is readable by reading the colored modules in the first region corresponding to the first colored image data as white modules. The colored modules in the second region also encode data that is readable by reading the colored modules in the second region corresponding to the second colored image data as white modules.

The data that is readable by reading the colored modules in the first region as white modules is the same as data encoded by the white modules in the first region corresponding to the white image data that is replaced. The data that is readable by reading the colored modules in the second region as white modules is the same as data encoded by the white modules in the second region corresponding to the white image data that is replaced.

Although specific embodiments have been illustrated and described herein it is manifestly intended that the scope of the claimed subject matter be limited only by the following claims and equivalents thereof.

What is claimed is:

1. A two-dimensional barcode, comprising:
a plurality of regions;
wherein a first region of the plurality of regions comprises black and white modules and one or more first colored modules;
wherein the one or more first colored modules encode data that is readable by reading the one or more first colored modules as white modules and different data that is readable by reading the one or more first colored modules based on their color;
wherein a second region of the plurality of regions comprises black and white modules only or comprises black and white modules and one or more second colored modules; and
wherein the one or more second colored modules encode data that is readable by reading the one or more second colored modules as white modules and different data that is readable by reading the one or more second colored modules based on their color.

2. The two-dimensional barcode of claim 1, wherein the data in the first region that is readable by reading the one or more first colored modules based on their color and the data encoded by the black and white modules in the second region that comprises the black and white modules only correspond to different stages in the evolution of the two-dimensional barcode, and wherein the data in the first region that is readable by reading the one or more first colored modules based on their color and the data in the second region that is readable by reading the one or more second colored modules based on their color correspond to different stages in the evolution of the two-dimensional barcode.

3. The two-dimensional barcode of claim 1, wherein the data in the first region that is readable by reading the one or more first colored modules based on their color is associated with the data in the second region that is readable by reading the one or more second colored modules based on their color.

4. The two-dimensional barcode of claim 1, wherein the data in the first region that is readable by reading the one or more first colored modules based on their color is configured to activate the data in the second region that is readable by reading the one or more second colored modules based on their color.

5. The two-dimensional barcode of claim 1, wherein each region of the plurality of regions contains its own error correction data.

6. The two-dimensional barcode of claim 1, wherein error correction data in the first and second regions can be used to reconstruct data originally stored in a third region of the plurality of regions region if the data originally stored in the third region is destroyed.

7. The two-dimensional barcode of claim 1, wherein the data in the first region that is readable by reading the one or more first colored modules based on their color is encrypted.

8. The two-dimensional barcode of claim 1, wherein the second region of the plurality of regions that comprises black and white modules only is offset from other regions of the plurality of regions.

9. A method of automatically generating a barcode, comprising:
encoding first data into first colored image data, the first colored image data corresponding to colored modules to be added to a first region of a plurality of regions of a two-dimensional barcode;
adding the encoded first data to the first region by replacing white image data corresponding to white modules in the first region with the first colored image data;
encoding second data into second colored image data, the second colored image data corresponding to colored modules to be added to a second region of the plurality of regions of the barcode; and
adding the encoded second data to the second region by replacing white image data corresponding to white modules in the second region with the second colored image data;
wherein the encoded first data is readable by reading the colored modules in the first region based on their color and the encoded second data is readable by reading the colored modules in the second region based on their color;
wherein the colored modules in the first region also encode data that is readable by reading the colored modules in the first region as white modules; and
wherein the colored modules in the second region also encode data that is readable by reading the colored modules in the second region as white modules.

10. The method of claim 9, wherein adding the encoded first data to the first region and adding the encoded second data to the second region occurs at different stages in an evolution of the barcode.

11. The method of claim 9, wherein the data that is readable by reading the colored modules in the first region as white modules is the same as data encoded by the white modules in the first region corresponding to the white image data that is replaced, and wherein the data that is readable by reading the colored modules in the second region as white modules is the same as data encoded by the white modules in the second region corresponding to the white image data that is replaced.

12. A computer-usable medium containing machine-readable instructions that configure a processor to allow a barcode generator to perform a method, comprising:
replacing white modules in a first region of a plurality of regions of a two-dimensional barcode with colored modules; and
replacing white modules in a second region of the plurality of regions of the two-dimensional barcode with colored modules;
wherein the colored modules in the first and second regions are configured to be interpreted by a first reader as white modules only or as black modules only; and
wherein the colored modules in the first and second regions are configured to be interpreted by a second reader based on their colors.

13. The computer-usable medium of claim 12, wherein the one or more colored modules in the first region configured to be interpreted by the first reader as black modules only cause the first region to be unreadable by the first reader, but not the second reader.

14. The computer-usable medium of claim 12, wherein replacing the white modules in the first region of the plurality of regions of the two-dimensional barcode with the colored modules comprises printing the colors of the colored modules over the white modules in the first region.

15. The computer-usable medium of claim 12, further comprising replacing the colored modules that replace the white modules in the first region with different colored modules during a different stage in the evolution of the two-dimensional barcode.
